(19) United States
(12) Patent Application Publication
(10) Pub. No.: US 2003/0170528 A1
(43) Pub. Date: Sep. 11, 2003

(54) Moldable separator plate for electrochemical devices and cells

(75) Inventors: Stanley F. Simpson, San Pedro, CA (US); Dacong Weng, Rancho Palos Verdes, CA (US)

Correspondence Address: Honeywell International, Inc., Law Dept. AB2, P.O. Box 2245, Morristown, NJ, 07962-9806, US

(73) Assignee: Honeywell International, Inc., Morristown, NJ

(21) Appl. No.: 10/095,908

(22) Filed: Mar. 11, 2002

(51) Int. Cl. H01M 8/02; H01M 4/94

(52) U.S. Cl. 429/38; 429/44; 429/13

(57) ABSTRACT

A flowfield plate for an electrochemical cell includes a plenum in fluid connection with a reactant fluid inlet and flow channels in fluid connection with a fluid outlet for draining waste fluids and gases from the electrochemical cell. The flowfield plate further includes lands extending between the plenum and face of the flowfield plate with holes extending through the lands, which place the plenum in fluid connection with the face of the flowfield plate. The plenum receives reactant fluid and distributes it evenly throughout the plenum to the holes. The holes are substantially perpendicular to the face of the flowfield plate, which is adjacent to the gas diffusion layer of the electrochemical cell, so that reactant fluid is delivered to the gas diffusion layer in such a way that the reactant fluid has a velocity component perpendicular to the surface of the gas diffusion layer.

### BACKGROUND OF THE INVENTION

The present invention generally relates to electrochemical devices and, more particularly, to monopolar and bipolar separator plates for proton exchange membrane, or polymer electrolyte membrane, electrolyzer cells and fuel cells.

An electrochemical cell is an energy conversion device that may use an electrochemical reaction to generate electricity, or vice versa, may use electricity to facilitate or drive an electrochemical reaction. For example, fuel cells typically use an electrochemical reaction to generate electricity, and electrolyzer cells typically use electricity to facilitate or drive an electrochemical reaction. Fuel cells are electrochemical energy conversion devices that are similar in some ways to the more familiar and commonly used storage batteries. Both batteries and fuel cells convert chemical energy into electricity efficiently. Both batteries and fuel cells use chemical reactants to produce electric power. Unlike a fuel cell, however, the reactants in a battery are stored internally, and when the reactants are consumed the battery must be recharged or replaced. In contrast, the reactants for a fuel cell may be stored externally, and simply replenished to continue operating the fuel cell.

A typical fuel cell includes porous electrodes, one of which is an anode and the other of which is a cathode, and an electrolyte, which typically separates the anode and cathode. The electrochemical reaction occurring in the fuel cell consists of two separate reactions: an oxidation half-reaction at the anode and a reduction half-reaction at the cathode. A fuel fluid enters the cell, diffuses to the anode, and is oxidized, releasing electrons to an external circuit connected to a load, where useful work may be performed, and positively charged ions, which travel through the electrolyte to the cathode. An oxidant enters the cell, diffuses to the cathode, and undergoes reduction via the electrons that have come from the anode by way of the external circuit. Oxidation products may be produced and expelled as waste. Because fuel cells are not perfect devices, fuel cells also produce heat as a byproduct.

A polymer electrolyte membrane fuel cell (PEM), also referred to as a proton exchange membrane fuel cell or solid polymer electrolyte fuel cell (SPE), is a fuel cell in which the electrolyte is a polymer membrane that permits the transport of protons, or H⁺ ions, from the “anode” side of the fuel cell to the “cathode” side of the fuel cell while preventing passage of reagent fluids which may be gases or liquids. In a typical PEM fuel cell, the anode and cathode are located in intimate contact with and on either side of the proton conductive membrane, i.e., the proton exchange membrane, in a manner so that the proton conductive membrane is sandwiched between the two electrodes, i.e., the anode and the cathode. The catalytic material within the electrodes may include any number of metals such as iridium, rhodium, and ruthenium, but usually includes platinum or platinum-containing alloys. Anode and cathode are typically about 5 to 10 microns in thickness, forming layers on the membrane, and are sometimes referred to as catalyst layers. The assembled anode-membrane-cathode layers may be referred to as the membrane and electrode (M&E).

The M&E is usually placed between two backing layers, which may be, for example, a porous carbon paper or carbon cloth about 100 to 300 microns in thickness. The porous backing layers, referred to as gas diffusion layers (GDLs), facilitate diffusion of the oxidant and fuel fluids, which may be liquids as well as gases, to the cathode and anode catalyst layers, with which the GDLs are in contact. The GDLs also serve to conduct electricity to and from the surfaces of the cathode and anode, and may also provide for the removal of excess fluids, for example, water, from the catalyst layers. The five-layered structure comprised of first GDL, cathode, membrane, anode, and second GDL is referred to as the membrane and electrode assembly (MEA).

The voltage generated between cathode and anode of an individual fuel cell, such as just described, operating at moderate levels of current density, is typically about 0.7 Volts (V). To obtain more useful higher voltages, the individual fuel cells may be connected together in series by electrically connecting the cathode of one cell to the anode of the next cell, and so on. One way to do this is to simply stack the cells cathode-to-anode in a manner to ensure intimate electrical contact between the cells. The voltage of the resulting stack is the sum of the voltages of the individual cells. The oxidant fluid in the cathode GDL of each cell, however, must be kept separated from the fuel fluid in the anode GDL of the adjacent cell.

To keep the oxidant fluid in the cathode GDL separated from the fuel fluid at the anode of the adjacent cell and provide electrical connection between adjacent cells, a separator plate may be inserted between each two adjacent cells to form a stack. The separator plate may also provide separate passageways, or flow channels, to allow oxidant fluid, liquid or gas, to flow past the cathode GDL and fuel fluid, liquid or gas, to flow past the anode GDL while keeping these fluids, typically gases, separated. For this reason, the separator plate may also be referred to as a flowfield plate. A flowfield plate with passage ways on both sides, or a separator plate, adapted for providing connection between adjacent cells may be referred to as bipolar. A flowfield plate with passage ways on only one side, or a separator plate, adapted for providing connection for cells at either end of a stack may be referred to as monopolar. Also typically included with the stack are ducts or manifolding to conduct the fuel and oxidant fluids, which may be either gaseous or liquid, into and out of the stack via fluid connection to the flowfield plates. Some of the fluid manifolds distribute fuel and oxidant to the flowfield plates, while some of the fluid manifolds remove unused fuel and oxidant as well as product water from the flowfield plates, which serve to provide fluid flow into and out of each fuel cell.

Thus, a separator plate may provide functions of electrically connecting adjacent cells, keeping reactant gases or liquids segregated between adjacent cells, distributing reactant fluids, gases or liquids, to the GDLs of anodes and cathodes in cells, and maintaining a uniform thermal profile between adjacent cells so that there are no extreme buildups of heat or radical temperature differences between different parts of the stack.

Achieving some or all of these functions imposes various physical requirements on the separator plate. For example, the separator plate needs high electrical conductivity to provide efficient electrical connection; the separator plate needs to be strong enough to withstand compressive and other forces in and on the stack and to be able to provide external electrical connections at the ends of the stack; the separator plate needs to be chemically inert to provide a reasonably long service life in the presence of fuel and oxidizing chemicals; the separator plate needs gas or liquid impermeability to permit segregation of the fuel and oxidant fluids; the separator plate needs high thermal conductivity for maintaining uniform thermal profile among cells in the stack; and lastly, it is desirable that the separator plate be relatively inexpensive.

Referring now to FIGS. 1A and 1B, a conventional flowfield plate 100 is shown. FIG. 1A is front view toward the face 102 of flowfield plate 100 and FIG. 1B is a side view of flowfield plate 100 showing face 102 to the left. In the conventional design exemplified by flowfield plate 100, flow channels 104 are machined or molded into face 102 of flowfield plate 100 in the form of grooves leaving lands 106, which provide walls or boundaries for the flowfields comprising flow channels 104 and lands 106. In addition, lands 106 help support the compressive forces imposed on flowfield plate 100 when it is assembled into a fuel cell stack. A conventional separator plate, or flowfield plate, as exemplified by flowfield plate 100, can be fabricated by any of several methods known in the art, including machining or molding. Flowfield plate 100 may be fabricated from an electrically conductive material, such as resin impregnated graphite, which has good physical properties as discussed above, but typically must be fabricated by being machined and is, therefore, relatively expensive. Flowfield plate 100 may also be fabricated from molded composite. Molded composite may be formed either by compression molding or injection molding. Compression molding is generally a slower process requiring conditions of higher temperature and pressure to form a part than injection molding, which starts with a liquid to form a part and is generally faster. Flowfield plate 100 may also be fabricated from metal or other suitable material as known in the art.

In operation, reactant fluid, which is typically a gas, although liquids may also be used, and may be fuel, such as hydrocarbon or hydrogen gases, or oxidant, such as air, enters flowfield plate 100 at reactant fluid inlet 108. Reactant fluid inlet 108 may be an opening from flow channel 104 through to the side of flowfield plate 100, or any other suitable arrangement, as known in the art, for connection and sealing to the fluid manifolds described above.

The reactant fluid flows in the direction indicated by flow direction arrows 110, as seen in FIG. 1A. Flow velocity arrows 114, shown in FIG. 1B, indicate that the main velocity component of the reactant fluid flow is in the plane of the flow channels, i.e. is substantially parallel to face 102 of flowfield plate 100, with almost no velocity component perpendicular to face 102. In order for the reactant fluids to reach the catalyst layer of the MEA, the reactant fluids must diffuse through the GDL of the MEA because, as shown by flow velocity arrows 114, there is substantially no velocity component perpendicular to the surface of the GDL which would facilitate reactant fluid flow through the GDL to the catalyst layer. In other words, there is no assistance from convection to aid the supply of reactant fluids to the catalyst. As a result of relying only on diffusion and not being able to effectively use convection, mass transfer limitations on the total electric current density from a fuel cell limit the electrical output of the fuel cell to a lower current density than what is either desirable or achievable. A big advantage, not seen in the prior art, would be the generation of convective gas streams within the GDL. Generation of convective gas streams within the GDL would maximize achievable currents via the convection advantage as well as the removal of water in the layers.

The reactant fluid, or gas, continues in the direction of flow direction arrows 110 while diffusing into the gas diffusion layer of the fuel cell and participating in the power generating electrochemical reactions of the fuel cell to form spent reactant fluid. The spent and remaining unspent reactant fluid, as well as product water, humidification water, and other waste product fluids from the electrochemical reactions of the fuel cell, are expelled from the GDL and exit flowfield plate 100 at fluid outlet 112. One problem that may be encountered is that humidification water, for example, may accumulate, i.e., fail to be expelled quickly or efficiently enough, in the GDL further inhibiting the diffusion of reactant fluids through the GDL. Fluid outlet 112 may be an opening from flow channel 104 through to the side of flowfield plate 100, or any other suitable arrangement, as known in the art, for connection and sealing to the fluid manifolds described above.

As can be seen, there is a need for a flowfield plate that provides reactant fluid flow aided by convection to facilitate reactant fluid flow through the GDL to the catalyst layer of a fuel cell. In particular, there is a need for an economical flowfield plate providing convection-aided reactant fluid flow to the GDL of a fuel cell, which can be efficiently manufactured.

### SUMMARY OF THE INVENTION

The present invention provides a flowfield plate in which reactant fluid flow is aided by convection to facilitate reactant fluid flow through the gas diffusion layer (GDL) to the catalyst layer of a fuel cell. In particular, the present invention provides a flowfield plate that can be economically and efficiently manufactured and in which reactant fluid flow to the GDL of a fuel cell is convection-aided.

In one aspect of the present invention, a flowfield plate for an electrochemical cell includes a plenum in fluid connection with a reactant fluid inlet and a flow channel in fluid connection with a fluid outlet for draining product fluids and gases from the electrochemical cell. The flowfield plate further includes lands extending between the plenum and the face of the flowfield plate with holes extending through the lands, which place the plenum in fluid connection with the face of the flowfield plate.

In another aspect of the present invention, a flowfield plate for an electrochemical cell, including a plenum in fluid connection with a reactant fluid inlet for receiving a reactant fluid, a flow channel in fluid connection with a fluid outlet, and lands extending between the plenum and the face of the flowfield plate, has holes extending through the lands that are substantially perpendicular to the face of the flowfield plate and that place the plenum in fluid connection with the face of the flowfield plate, so that the reactant fluid is delivered to the GDL of the electrochemical cell in such a way that the reactant fluid has a velocity component perpendicular to the surface of the GDL, which is adjacent to the face of the flowfield plate.

In another aspect of the present invention, a flowfield plate for an electrochemical cell includes a plenum in fluid connection with a reactant fluid inlet for receiving a reactant fluid, a flow channel in fluid connection with a fluid outlet, lands extending between the plenum and the face of the flowfield plate, and holes extending through the lands that are substantially perpendicular to the face of the flowfield plate and that place the plenum in fluid connection with the face of the flowfield plate, so that the reactant fluid is delivered to the GDL of the electrochemical cell in such a way that the reactant fluid has a velocity component perpendicular to the surface of the GDL, which is adjacent to the face of the flowfield plate. The flowfield plate further includes electrically conductive struts disposed in the plenum, which may improve the conductivity of the flowfield plate and support the walls of the plenum against compressive forces.

In another aspect of the present invention, a method includes the steps of supplying a reactant fluid to a plenum, distributing the reactant fluid from the plenum via a number of holes, where the holes place the plenum in fluid connection with the face of a flowfield plate, which is adjacent to a GDL of an electrochemical cell, and delivering the reactant fluid to the GDL. The holes may be substantially perpendicular to the face of the flowfield plate so as to impart a velocity component to the reactant fluid, which is perpendicular to the surface of the GDL. The method may further include steps of draining the reactant fluid from the electrochemical cell via a flow channel in the flowfield plate, forcefully removing waste product fluids from the electrochemical cell via the flow channel, and hydrating the membrane and electrode (M&E) of the electrochemical cell via the flow channel. The method may also include a step of fabricating the flowfield plate using injection molding.

These and other features, aspects and advantages of the present invention will become better understood with reference to the following drawings, description and claims.

### BRIEF DESCRIPTION OF THE DRAWINGS

FIG. 1A and FIG. 1B are orthographic projection front and side views, respectively, of a flowfield plate for a polymer electrolyte membrane (PEM) electrochemical cell as previously fabricated;

FIG. 2A and FIG. 2B are orthographic projection front and side views, respectively, of a flowfield plate for a PEM electrochemical cell according to an embodiment of the present invention;

FIG. 3 is a side view of a flowfield plate for a PEM electrochemical cell, similar to that of FIG. 2B but oriented horizontally, according to another embodiment of the present invention;

FIG. 4A is a side view of a flowfield plate for a PEM electrochemical cell in juxtaposition with other components of the electrochemical cell, according to an embodiment of the present invention;

FIG. 4B is a magnified view of the portion, indicated by circle 4B in FIG. 4A, of the flowfield plate and other components of the electrochemical cell shown in FIG. 4A; and

FIG. 5 is a side view of a functional bipolar flowfield plate for PEM electrochemical cells, with an internal barrier for segregating fluid flows to anode and cathode and conductive struts for increasing electrical conductivity, according to an embodiment of the present invention.

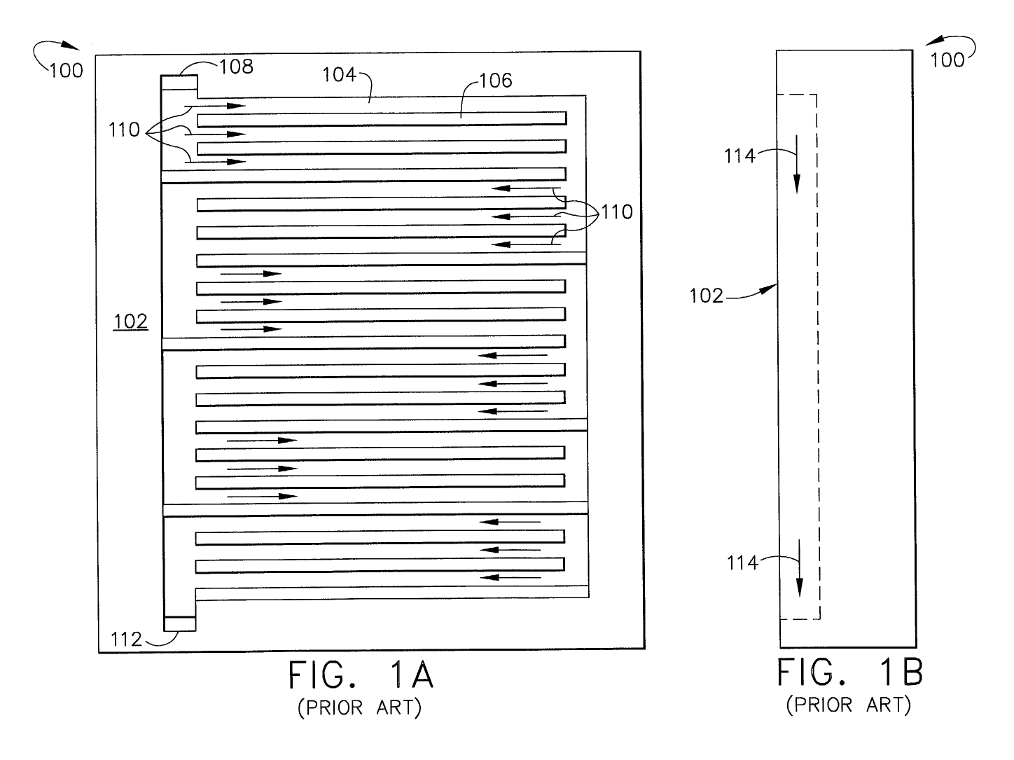

### DETAILED DESCRIPTION OF THE INVENTION

The following detailed description is of the best currently contemplated modes of carrying out the invention. The description is not to be taken in a limiting sense, but is made merely for the purpose of illustrating the general principles of the invention, since the scope of the invention is best defined by the appended claims.

The present invention provides a flowfield plate for electrochemical devices such as fuel cells and electrolyzer cells. The invention may be used, for example, in polymer electrolyte membrane (PEM) fuel cells and in direct methanol fuel cells (DMFC). Although the present invention is illustrated referring to fuel cells as examples, it should be understood that the invention is generally applicable to other electrochemical devices, such as electrolyzer cells, as well.

In one embodiment of the present invention, a flowfield plate provides reactant fluid flow, aided by convection to facilitate reactant fluid flow through the gas diffusion layer (GDL), to the catalyst layer of the membrane and electrode assembly (MEA) of a fuel cell. The flowfield plate of the present invention can be economically and efficiently manufactured due to successful development of injection molding technology for the flowfield plate. Without such technology, fabrication of the flowfield plate according to one embodiment of the present invention would require extensive machining to create the hollow structure, which would be prohibitively expensive and time consuming. With the ability to injection mold electrically conductive resin, one can create the hollow structure of the flowfield plate according to one embodiment readily with no additional machining. The holes in the lands can be either incorporated directly in the injection molding process or drilled separately following the injection molding portion of the fabrication of the flowfield plate. The use of a hollow structure as a plenum to evenly distribute the pressure of the reactant fluid to all portions of the face of the flowfield plate, and attaining convective flow of the reactant fluid gases, achieves significant advantages over the prior art by increasing the electrical current density output of the fuel cell and the fuel cell stack and minimizing electrode concentration overpotential by improving fuel and oxidant mass transfer.

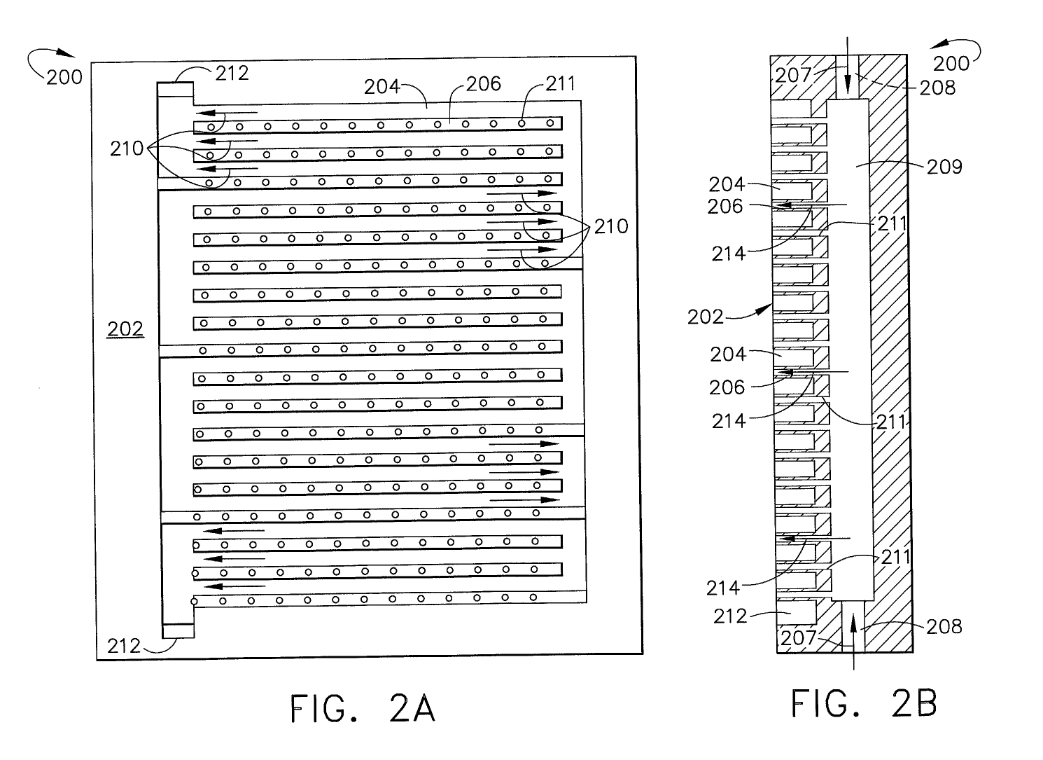

Referring now to FIGS. 2A and 2B, flowfield plate 200 is shown according to one embodiment. FIG. 2A is front view toward face 202 of flowfield plate 200 and FIG. 2B is a side view of flowfield plate 200 showing face 202 to the left. In the embodiment exemplified by flowfield plate 200, flow channels 204 in face 202 of flowfield plate 200 may be created by injection molding. Flow channels 204 may have the form of grooves separated by lands 206, which provide walls or boundaries for the flowfields comprising flow channels 204 and lands 206. The cross section of flow channels 204 may be substantially rectangular, as shown in FIG. 2B, or may have any other form suitable for the passage of fluid. In addition, lands 206 help support the compressive forces imposed on flowfield plate 200 when it is assembled into a fuel cell stack. Flowfield plate 200 may be fabricated from an electrically conductive material, such as a graphite-filled conductive composite, or other suitable material as known in the art.

In operation, reactant fluid 207, which is typically a gas and may be fuel, such as hydrocarbon or hydrogen gases, or oxidant, such as air, enters flowfield plate 200 at reactant fluid inlet 208. Reactant fluid inlet 208 may be an opening from plenum 209 through to the side of flowfield plate 200, or a pair of openings from plenum 209 through to the side of flowfield plate 200, as seen in FIG. 2B, or may be any other suitable arrangement, as known in the art, for connecting and sealing to the fluid manifolds described above. Plenum 209 may be a hollow chamber formed in flowfield plate 200 by the injection molding process during fabrication of flowfield plate 200.

Reactant fluid 207 flows into plenum 209 where the reactant fluid pressure is evenly distributed over the extent of face 202 of flowfield plate 200 and over holes 211 in the wall of plenum 209. Holes 211 extend through lands 206 from plenum 209 to face 202, and place plenum 209 in fluid connection with face 202 of flowfield plate 200. In the example embodiment shown in FIGS. 2A and 2B, holes 211 may be substantially perpendicular to face 202. Holes 211 may be configured in any manner, however, to deliver reactant fluid 207 to the GDL or catalyst layer of the MEA so as to provide reactant fluid 207 with a velocity component that is perpendicular to face 202, or perpendicular to the surface of the GDL or catalyst layer.

Flow velocity arrows 214, shown in FIG. 2B, indicate that the main velocity component of the reactant fluid flow may be perpendicular to the plane of the flow channels, i.e. is substantially perpendicular to face 202 of flowfield plate 200, with almost no velocity component parallel to face 202. Thus, reactant fluid 207 may be impelled directly toward the catalyst layer of the MEA, as shown by flow velocity arrows 214, with a velocity component perpendicular to the surface of the GDL which facilitates reactant fluid gas flow through the GDL to the catalyst layer. In other words, convection assists diffusion of the supply of reactant fluid 207 through the GDL to the catalyst. As a result of effectively using convection, the mass transfer limitations on the total electric current density from the fuel cell may be much lower and reduce the mass transfer overpotential of the cell.

Reactant fluid 207 exiting the fuel cell continues in the direction of flow direction arrows 210 through flow channels 204 and exits flowfield plate 200 at fluid outlets 212. Fluid outlets 212 may be openings from flow channels 204 through to the sides of flowfield plate 200, or any other suitable arrangement, as known in the art, for connection and sealing to the fluid manifolds described above.

In addition, because of the fluid dynamic energy transmitted from plenum 209 through holes 211 and the convective action of reactant fluid 207, product water and other waste product fluids from the electrochemical reactions of the fuel cell will be forcefully removed from the fuel cell through flow channels 204 and exit flowfield plate 200 via fluid outlets 212 with no accompanying flooding of the GDL and catalyst layer.

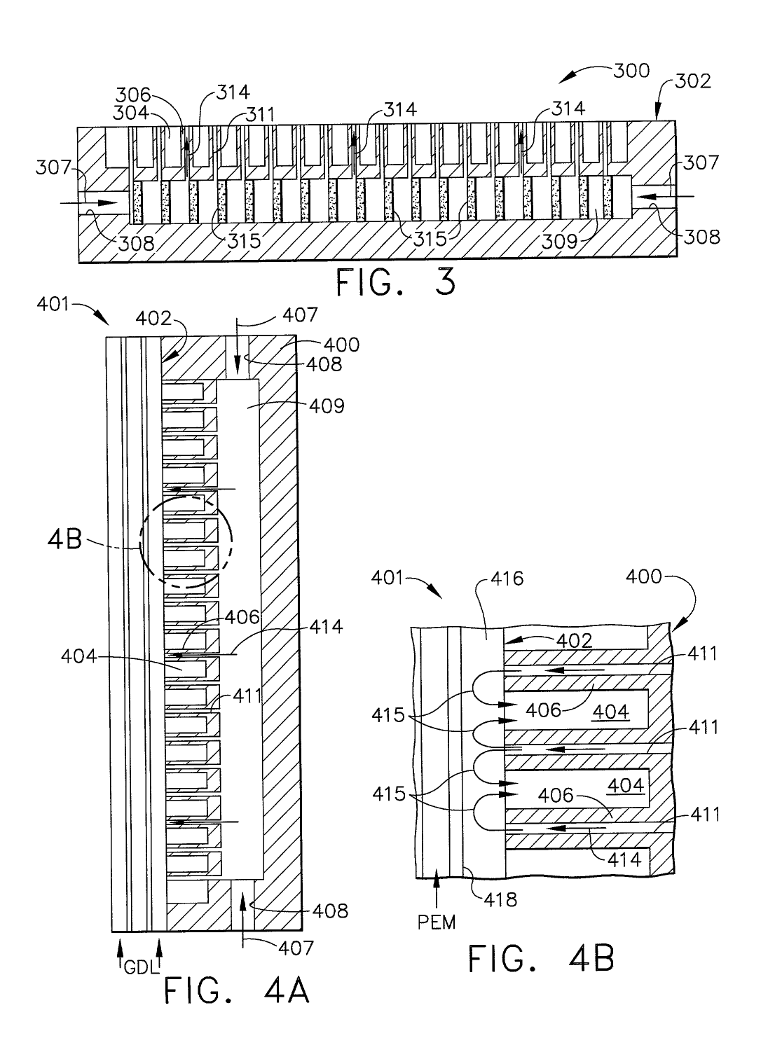

FIG. 3 is a side view, similar to that of FIG. 2B but oriented horizontally, showing flowfield plate 300 with face 302 to the top. The embodiment exemplified by flowfield plate 300 is similar to the embodiment illustrated in FIGS. 2A and 2B, and similar features have been numbered correspondingly. For example, flowfield plate 300 includes flow channels 304, lands 306, reactant fluid inlet 308, plenum 309, and holes 311, all of which function as the correspondingly numbered features of FIGS. 2A and 2B. Reactant fluid 307 enters flowfield plate 300 at reactant fluid inlet 308, may be distributed evenly to holes 311 by plenum 309, and flows through holes 311 in lands 306 in the direction of flow velocity arrows 314 to the GDL of a fuel cell.

The embodiment shown in FIG. 3 further includes electrically conductive struts 315 disposed in plenum 309. Electrically conductive struts 315 provide electrical conductivity, which may be lost due to the hollow chamber structure of plenum 309 in flowfield plate 300, through flowfield plate 300. Electrically conductive struts 315 may be formed within the open structure during the injection molding process. Electrically conductive struts 315 should be formed so as not to interfere with distribution of reactant gas pressure throughout- plenum 309 and may be fabricated so as to support compressive forces that act on flowfield plate 300 when flowfield plate 300 is assembled into a fuel cell stack.

FIGS. 4A and 4B provide an illustration of the functioning of flowfield plate 400 when implemented as part of fuel cell 401 in accordance with one embodiment. Flowfield plate 400 may be positioned with face 402 against, or adjacent to, porous GDL 416 of fuel cell 401. As seen in FIG. 4A, reactant gas 407 may enter flowfield plate 400 through reactant fluid inlet 408 into plenum 409 and may exit plenum 409 through holes 411 in lands 406 with velocity component perpendicular to the surface of GDL 416, as indicated by flow velocity arrows 414.

As seen in FIG. 4B, reactant gas 407 may exit flowfield plate 400 and penetrate GDL 416 to reach catalyst layer 418 via convection, as indicated by flow direction arrows 415. Thus, reactant gas 407 may penetrate GDL 416 to reach catalyst layer 418 not simply by diffusion but also by convection, as a result of the directional component of the gas velocity that is perpendicular to GDL 416 and that is indicated by flow velocity arrows 414. Reactant gas 407 may react at catalyst layer 418 and excess gas may be removed from the fuel cell via channels 404, as also indicated in FIG. 4B by flow direction arrows 415. As described above, product water, as well as other waste products and unspent reactant gas, also may be swept efficiently from catalyst layer 418 and GDL 416 via channels 404.

FIG. 4B also illustrates a mass transfer advantage of one embodiment. As seen in FIG. 4B, reactant gas 407, as indicated by flow direction arrows 415, may reach all areas of the catalyst layer much more efficiently as a result of the convection within GDL 416. Thus, it may be possible to widen the land width to decrease the interfacial electrical resistance between electrically conductive GDL 416 and bipolar flowfield plate 400 without experiencing degraded performance resulting from reactant gas 407 not reaching catalyst areas that lie directly beneath lands 406.

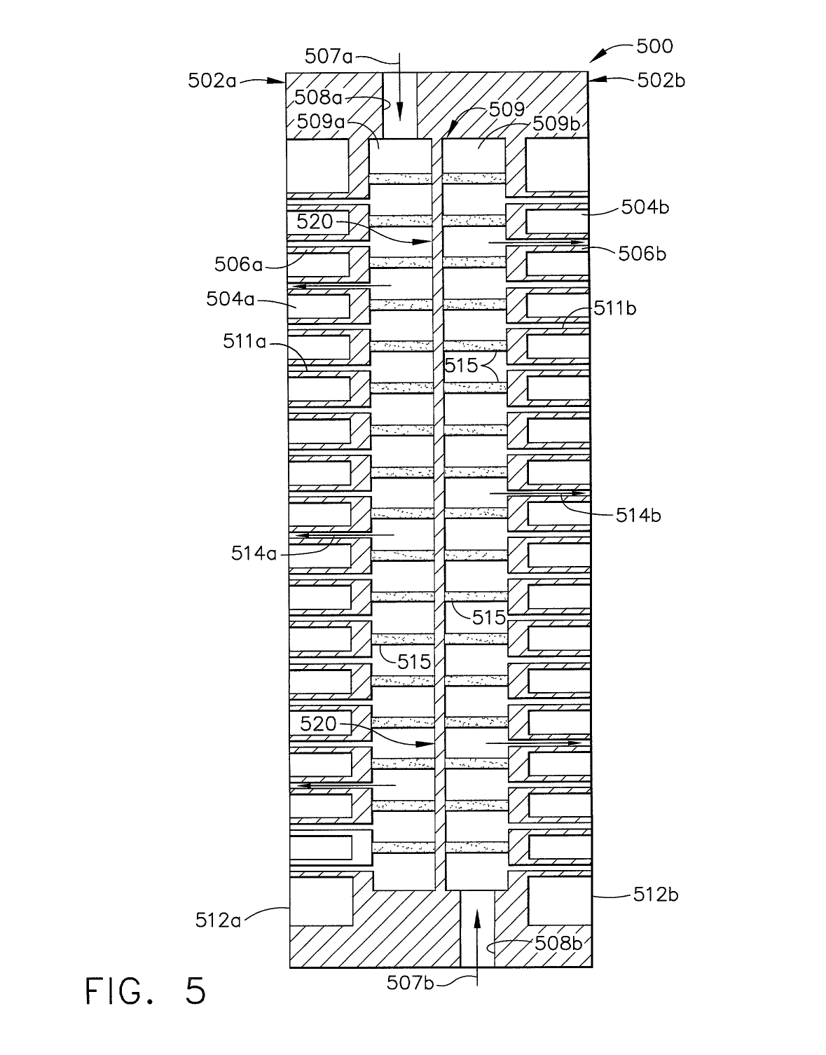

FIG. 5 is a side view, similar to that of FIG. 2B, illustrating flowfield plate 500 according to another embodiment, which may be suitable for use as a bipolar separator plate for separating and interconnecting fuel cells in a fuel cell stack. By slightly widening the flowfield plate and adding internal barrier 520 in the center of flowfield plate 500 to keep gases separate, a single bipolar flowfield plate may be formed that can supply gases to both anode and cathode. Internal barrier 520 divides plenum 509 into first chamber 509a and second chamber 509b, which are not in fluid communication with each other so that gases in the two chambers may be kept segregated from each other. The embodiment of flowfield plate 500 shown in FIG. 5 also includes electrically conductive struts 515 disposed in plenum 509. Electrically conductive struts 515 are formed and function as described above in connection with FIG. 3.

By way of an example, by juxtaposing flowfield plate 500 between a first fuel cell with face 502a adjacent the first fuel cell and a second fuel cell with opposing face 502b adjacent the second fuel cell, reactant fluid 507a may be supplied to chamber 509a through reactant fluid inlet 508a and evenly distributed through holes 511a in lands 506a with perpendicular velocity components indicated by flow velocity arrows 514a to a first GDL of the first fuel cell. Unspent reactant gas, product water, and other waste products may be swept up from the first GDL through flow channels 504a and forcefully removed from the first fuel cell via fluid outlet 512a. At the same time, reactant fluid 507b may be supplied to chamber 509b through reactant fluid inlet 508b and evenly distributed through holes 511b in lands 506b with perpendicular velocity component indicated by flow velocity arrows 514b to a second GDL of the second fuel cell. Unspent reactant gas, product water, and other waste products may be swept up from the second GDL through flow channels 504b and forcefully removed from the second fuel cell via fluid outlet 512b. In this example, reactant fluid 507a may be an oxidant fluid, such as air, and reactant fluid 507b may be a fuel fluid, such as a gaseous hydrocarbon, so that fluid flow plate 500 delivers oxidant fluid to the cathode of the first fuel cell and delivers fuel fluid to the anode of the second fuel cell, while keeping these fluids separated.

The present invention may use a hollow chamber structure, such as a plenum, to evenly distribute the pressure of reactant fluids to all portions of the face of a flowfield plate, attaining convective flow of the reactant fluid gases in the gas diffusion layer of a fuel cell. The associated improvement in mass transfer may effect an increase in electrical current density output of the fuel cell. In addition, the improvement in mass transfer may allow a widening of the width of the lands, resulting in increased contact area between the lands and the GDL, which decreases the interfacial electrical resistance between the electrically conductive GDL of the fuel cell and the bipolar flowfield plate. Because of the improved mass transfer, the increased contact area between the lands and the GDL may be achieved without experiencing degraded performance, which could result from widening the lands, by reactant gas not reaching catalyst areas that lie directly beneath the lands.

Moreover, the flowfield plate of the present invention may be economically and efficiently manufactured using injection molding technology. With the ability to injection mold conductive resin, fabrication of the hollow structure of the flowfield plate, according to one embodiment, may be readily achieved without prohibitively expensive, time consuming, and extensive machining to create the hollow structure.

It should be understood, of course, that the foregoing relates to preferred embodiments of the invention and that modifications may be made without departing from the spirit and scope of the invention as set forth in the following claims.

We claim:

1. A flowfield plate for an electrochemical cell comprising:
a plenum in fluid connection with a reactant fluid inlet;
a flow channel in fluid connection with a fluid outlet;
a land extending between said plenum and a face of said flowfield plate;
a hole extending through said land, said hole placing said plenum in fluid connection with said face of said flowfield plate.

2. The flowfield plate of claim 1, wherein said plenum receives a reactant fluid via said reactant fluid inlet and distributes said reactant fluid via said hole.

3. The flowfield plate of claim 2, wherein said hole is configured to deliver said reactant fluid to a gas diffusion layer of said electrochemical cell, such that said reactant fluid has a velocity component perpendicular to a surface of said gas diffusion layer, said gas diffusion layer being adjacent said face.

4. The flowfield plate of claim 2, wherein said hole is configured to deliver said reactant fluid to a catalyst layer of said electrochemical cell, such that said reactant fluid has a velocity component perpendicular to a surface of said catalyst layer, said catalyst layer being disposed near said face.

5. The flowfield plate of claim 1, wherein said flowfield plate is fabricated using molding.

6. The flowfield plate of claim 1, wherein said hole is formed by drilling said hole in and through said land.

7. The flowfield plate of claim 1, further comprising conductive struts disposed in said plenum.

8. The flowfield plate of claim 1, wherein said flow channel is in fluid connection with a hydration source for hydrating an MEA of said electrochemical cell via said flow channel.

9. The flowfield plate of claim 1, wherein a waste product fluid is forcefully removed from said electrochemical cell through said flow channel and via said fluid outlet.

10. The flowfield plate of claim 1, wherein said hole is substantially perpendicular to said face.

11. The flowfield plate of claim 1, further comprising
an internal barrier disposed in said plenum, said internal barrier segregating said plenum into a first chamber and a second chamber, wherein said reactant fluid inlet is in fluid connection with said first chamber of said plenum;
a second reactant fluid inlet for receiving a second reactant fluid, said second reactant fluid inlet being in fluid connection with said second chamber of said plenum;
a second flow channel in fluid connection with a second fluid outlet;
a second land extending between said plenum and an opposing face of said flowfield plate;
a second hole extending through said second land, said second hole placing said plenum in fluid connection with said opposing face of said flowfield plate, wherein said second hole is configured to distribute said second reactant fluid such that said second reactant fluid has a velocity component perpendicular to said opposing face.

12. The flowfield plate of claim 11, wherein said flowfield plate is juxtaposed between two electrochemical cells so as to deliver a first reactant fluid to a first gas diffusion layer on a cathode of a first electrochemical cell, such that said first reactant fluid has a velocity component perpendicular to a first surface of said first gas diffusion layer and a second reactant fluid to a second gas diffusion layer on an anode of a second electrochemical cell, such that said second reactant fluid has a velocity component perpendicular to a second surface of said second gas diffusion layer.

13. The flowfield plate of claim 11, wherein said flowfield plate is juxtaposed between two electrochemical cells so as to deliver a first reactant fluid to a first catalyst layer on a cathode of a first electrochemical cell, such that said first reactant fluid has a velocity component perpendicular to a first surface of said first catalyst layer and a second reactant fluid to a second catalyst layer on an anode of a second electrochemical cell, such that said second reactant fluid has a velocity component perpendicular to a second surface of said second catalyst layer.

14. A flowfield plate for an electrochemical cell comprising:
a plenum in fluid connection with a reactant fluid inlet for receiving a reactant fluid;
a flow channel in fluid connection with a fluid outlet;
a land extending between said plenum and a face of said flowfield plate;
a hole extending through said land, said hole placing said plenum in fluid connection with said face of said flowfield plate, said hole configured so as to deliver said reactant fluid to a catalyst layer of said electrochemical cell, such that said reactant fluid has a velocity component perpendicular to a surface of said catalyst layer, said catalyst layer being disposed near said face.

15. The flowfield plate of claim 14, wherein said flowfield plate is fabricated using molding.

16. The flowfield plate of claim 14, further comprising conductive struts disposed in said plenum.

17. The flowfield plate of claim 14, wherein said flow channel is in fluid connection with a hydration source for hydrating an MEA of said electrochemical cell via said flow channel.

18. The flowfield plate of claim 14, wherein a waste product fluid is forcefully removed from said electrochemical cell through said flow channel and via said fluid outlet.

19. The flowfield plate of claim 14, further comprising an internal barrier disposed in said plenum, said internal barrier segregating said plenum into a first chamber and a second chamber, wherein said reactant fluid inlet is in fluid connection with said first chamber of said plenum;
a second reactant fluid inlet for receiving a second reactant fluid, said second reactant fluid inlet being in fluid connection with said second chamber of said plenum;
a second flow channel in fluid connection with a second fluid outlet;
a second land extending between said plenum and an opposing face of said flowfield plate;
a second hole extending through said second land, said second hole placing said plenum in fluid connection with said opposing face of said flowfield plate, said second hole configured so as to deliver said second reactant fluid to a second catalyst layer of said electrochemical cell, such that said second reactant fluid has a velocity component perpendicular to a surface of said second catalyst layer, said second catalyst layer being disposed near said opposing face.

20. The flowfield plate of claim 19, wherein said flowfield plate is juxtaposed between two electrochemical cells so as to deliver a first reactant fluid to a first gas diffusion layer on a cathode of a first electrochemical cell, such that said first reactant fluid has a velocity component perpendicular to a first surface of said first gas diffusion layer and said second reactant fluid to a second gas diffusion layer on an anode of a second electrochemical cell, such that said second reactant fluid has a velocity component perpendicular to a second surface of said second gas diffusion layer.

21. An injection molded flowfield plate for an electrochemical cell comprising:
a plenum in fluid connection with a reactant fluid inlet for receiving a reactant fluid;
electrically conductive struts disposed in said plenum;
a flow channel in fluid connection with a fluid outlet;
a land extending between said plenum and a face of said flowfield plate;
a hole extending through said land, said hole placing said plenum in fluid connection with said face of said flowfield plate, said hole being substantially perpendicular to said face, whereby said reactant fluid is delivered with a velocity component perpendicular to said face, to a gas diffusion layer of said electrochemical cell, said gas diffusion layer being adjacent said face.

22. The injection molded flowfield plate of claim 21, further comprising:
an internal barrier disposed in said plenum, said internal barrier segregating said plenum into a first chamber and a second chamber, wherein said reactant fluid inlet is in fluid connection with said first chamber of said plenum;
a second reactant fluid inlet for receiving a second reactant fluid, said second reactant fluid inlet being in fluid connection with said second chamber of said plenum;
electrically conductive struts disposed in said plenum;
a second flow channel in fluid connection with a second fluid outlet;
a second land extending between said plenum and an opposing face of said flowfield plate;
a second hole extending through said second land, said second hole placing said plenum in fluid connection with said opposing face of said flowfield plate, said second hole being substantially perpendicular to said opposing face, whereby said second reactant fluid is delivered with a velocity component perpendicular to said opposing face, to a second gas diffusion layer of a second electrochemical cell, said second gas diffusion layer being adjacent said opposing face.

23. A method comprising steps of:
supplying a reactant fluid to a plenum;
distributing said reactant fluid from said plenum via a plurality of holes, wherein said holes place said plenum in fluid connection with a face of a flowfield plate, to a gas diffusion layer of an electrochemical cell;
draining said reactant fluid from said electrochemical cell via a flow channel in said flowfield plate.

24. The method of claim 23 wherein said holes are substantially perpendicular to said face so as to impart a velocity component to said reactant fluid, said velocity component being perpendicular to a surface of said gas diffusion layer.

25. The method of claim 23 wherein said holes are configured to impart a velocity component to said reactant fluid, said velocity component being perpendicular to a surface of said gas diffusion layer.

26. The method of claim 23 further comprising a step of fabricating said flowfield plate using injection molding.

27. The method of claim 23 further comprising a step of hydrating an M&E of said electrochemical cell via said flow channel.

28. The method of claim 23 further comprising a step of forcefully removing a waste product fluid from said electrochemical cell via said flow channel.
